(19) United States
(12) Patent Application Publication
(10) Pub. No.: US 2012/0038115 A1
(43) Pub. Date: Feb. 16, 2012

(54) Anti-Extrusion Seal for High Temperature Applications

(75) Inventors: Adan Hernandez Herrera, Houston, TX (US); James H. Dudley, Spring, TX (US)

(73) Assignee: HALLIBURTON ENERGY SERVICES, INC., Houston, TX (US)

(21) Appl. No.: 13/146,591

(22) PCT Filed: Feb. 11, 2010
(86) PCT No.: PCT/US10/23880

§ 371 Date: Oct. 5, 2011

Related U.S. Application Data
(60) Provisional application No. 61/152,026, filed on Feb. 12, 2009.

(51) Int. Cl. F16J 15/24; F16J 15/26

(52) U.S. Cl. 277/337; 277/336

(57) ABSTRACT

A sealing system between a tubular and a chassis. In some embodiments, the sealing system includes a sealing member and an outer ring. The sealing member is compressed between the chassis and the tubular. The sealing member has a temperature and comprises a resilient material that is expandable as the temperature increases and contractible as the temperature decreases. The outer ring is displaceable to close an annulus between an outer surface of the outer ring and the inner surface of the tubular by expansion of the sealing element, whereby the sealing member is prevented from extruding into the annulus. Further, the outer ring comprises a compliant material that is deformable under load from the sealing element as the sealing element expands.

### STATEMENT REGARDING FEDERALLY SPONSORED RESEARCH OR DEVELOPMENT

Not Applicable.

### BACKGROUND

To form an oil or gas well, a bottom hole assembly (BHA), including components such as a motor, steering assembly, one or more drill collars, and a drill bit, is coupled to a length of drill pipe to form a drill string. Electronics for performing various downhole operations may be positioned in a chassis, which is, in turn, located within the drill string. The drill string is then inserted downhole, where drilling commences. During drilling, drilling fluid, or “drilling mud,” is circulated down through the drill string to lubricate and cool the drill bit as well as to provide a vehicle for removal of drill cuttings from the borehole.

Seals are positioned between the electronics chassis and adjacent drill string tubular(s) to prevent exposure of the electronics positioned in the chassis to drilling fluid. Like the remaining components of the drill string, the seals are exposed to high pressure loads resulting from the weight of the drilling fluid contained in the drill string and high temperature loads resulting from heat generated by contact between the drill bit and formation. High pressure and/or temperature loads may be problematic for the seals and potentially cause failure.

Some conventional seals are formed of compliant, thermally sensitive material that expands when exposed to high temperature and contracts when the surrounding temperature decreases. To ensure adequate sealing between the electronics chassis and the adjacent drill string tubular at relatively low temperatures, often the seal is preloaded, or compressed between the chassis and tubular to some pre-determined load. Later, when the seals are exposed to higher temperatures, the temperature sensitive material of the seals causes them to expand. As a result, the seals may extrude into annular spaces between the electronics chassis and adjacent tubular. High pressure loads acting on the compliant seal may promote extrusion of the seal into the annular spaces. Over time, repeated contraction and extrusion of the seals due to temperature changes and high-pressure loads may cause damage to the seals such that they fail and pressurized drilling fluid begins to leak between the electronics chassis and adjacent tubular, whereby the electronics positioned in the chassis are exposed to the drilling fluid.

### SUMMARY OF DISCLOSED EMBODIMENTS

A system for sealing between a tubular and a chassis is disclosed. In some embodiments, the sealing system includes a sealing member and an outer ring. The sealing member is compressed between the chassis and the tubular. The sealing member has a temperature and comprises a resilient material that is expandable as the temperature increases and contractible as the temperature decreases. The outer ring is displaceable to close an annulus between an outer surface of the outer ring and the inner surface of the tubular by expansion of the sealing element, whereby the sealing member is prevented from extruding into the annulus. Further, the outer ring comprises a compliant material that is deformable under load from the sealing element as the sealing element expands.

In some embodiments, the sealing system includes a sealing member compressed between the chassis and the tubular and an outer ring disposed adjacent the sealing member and slideably engaging a radially extending surface of the chassis. The sealing member has a temperature and comprises a resilient material that is expandable as the temperature increases and contractible as the temperature decreases. The outer ring includes a substantially axially extending inner surface, an angled surface extending from the inner surface and engaging the sealing member, and a substantially axially extending outer surface disposed radially inward of an inner surface of the tubular. The sealing member is expandable to displace the outer ring radially outward, whereby an annulus between the outer surface of the outer ring and an inner surface of the tubular is closed and the sealing member is deflected by the angled surface of the outer ring away from the annulus.

In some embodiments, the sealing system includes a sealing member compressed between the chassis and the tubular, an inner ring disposed adjacent the sealing member and slideably engaging an axially extending surface of the chassis, and an outer ring disposed radially outward of the inner ring. The sealing member has a temperature and comprises a resilient material that is expandable as the temperature increases and contractible as the temperature decreases. The inner ring has an axially extending outer surface and an angled surface extending from the outer surface. The outer ring has a substantially axially extending inner surface, an angled surface extending from the inner surface and slideably engaging the angled surface of the inner ring, and a substantially axially extending outer surface disposed radially inward of an inner surface of the tubular. The sealing member is expandable to axially displace the inner ring, whereby the outer ring displaces radially outward to close an annulus between the outer surface of the outer ring and an inner surface of the tubular, whereby the sealing member is prevented from extruding into the annulus.

Thus, embodiments described herein comprise a combination of features and characteristics intended to address various shortcomings associated with certain prior devices. The various characteristics described above, as well as other features, will be readily apparent to those skilled in the art upon reading the following detailed description of the preferred embodiments, and by referring to the accompanying drawings.

### BRIEF DESCRIPTION OF THE DRAWINGS

For a more detailed description of the disclosed embodiments, reference will now be made to the accompanying drawings, wherein:

FIG. 1 is a cross-sectional view of an embodiment of an anti-extrusion seal for high temperature applications in accordance with the principles disclosed herein;

FIG. 2 is a cross-sectional view of the anti-extrusion seal of FIG. 1 after preloading;

FIG. 3 is a cross-sectional view of the anti-extrusion seal of FIG. 1 after expansion due to exposure to higher temperatures;

FIG. 4 is a cross-sectional view of another embodiment of an anti-extrusion seal for high temperature applications in accordance with the principles disclosed herein;

FIG. 5 is a cross-sectional view of the anti-extrusion seal of FIG. 4 after expansion due to exposure to higher temperatures; and

FIG. 6 is a cross-sectional view of the anti-extrusion seal of FIG. 3 after further expansion due to exposure to higher temperatures.

### DETAILED DESCRIPTION OF THE DISCLOSED EMBODIMENTS

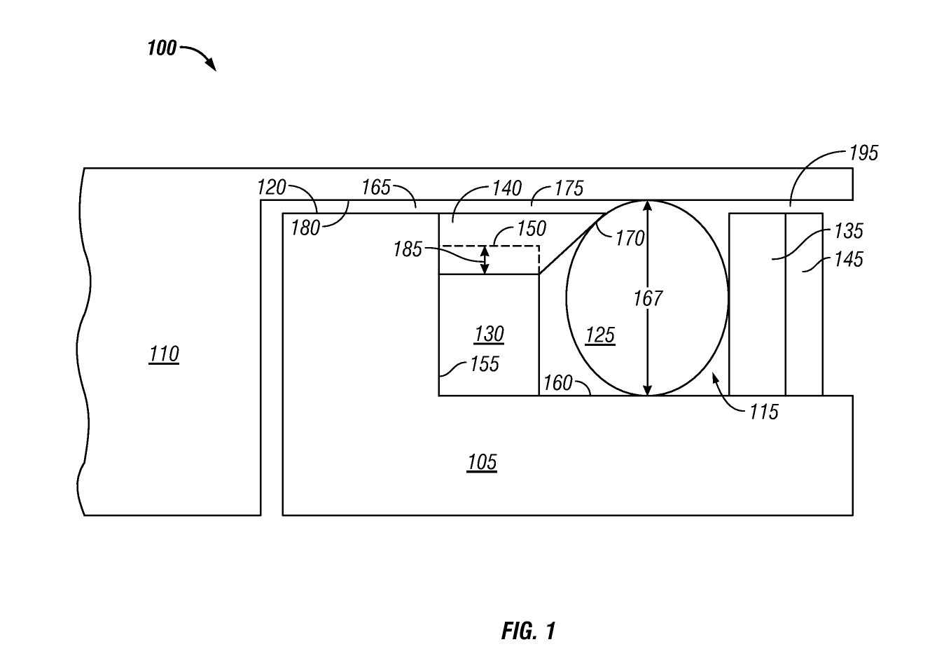

Referring now to FIG. 1, an anti-extrusion seal 100 in accordance with the principles disclosed herein is depicted between a tubular 110 and an insert 105 disposed therein. In some embodiments, tubular 110 is a component of form a drill string for creating a well bore, such as but not limited to a drill collar, and insert 105 is a chassis within which electronics (not shown) for downhole measurements are positioned. Seal 100 is seated in a groove 115 disposed in the outer surface 120 of insert 105 and, when preloaded as will be described, provides a barrier to fluid flow into an annular space 165 between insert 105 and tubular 110 to protect the electronics positioned in insert 105.

Seal 100 includes a sealing member 125 positioned between a resilient ring 130 and an inner preload ring 135, an angular ring 140 disposed radially outward of resilient ring 130, and an outer preload ring 145 abutting inner preload ring 135. Sealing member 125 is compliant or flexible, and in some embodiments, comprises elastomeric material. Thus, sealing member 125 deforms in response to pressure loads, such as pressure loads from drilling fluid passing through tubular 110. Further, sealing member 125 may be responsive to temperature change. As such, sealing member 125 may expand when exposed to temperatures exceeding the ambient temperature, and contract again when exposed to lower temperatures.

Moreover, sealing member 125 has a diameter 167, or other equivalent dimension, which exceeds the radial clearance between an outer surface 160 of insert 105 and an inner surface 180 of tubular 110. Consequently, sealing member 125 must be compressed to between insert 105 and tubular 110 when installed, as shown, thereby preloading seal 100 to a degree. Compressing sealing member 125 in this manner preloads seal 100 to a degree. Inner preload ring 135 and outer preload ring 145 enable further preloading of sealing member 125, as will be described. In some embodiments, outer preload ring 145 is a Belleville washer or a wave spring.

Preloading of sealing member 125 occurs at ambient temperature, when sealing member 125 assumes its natural state in the absence of thermal expansion. Preloading of sealing member 125 involves compressing sealing member 125 sufficiently within groove 115 to cause sealing member 125 to engage both inner surface 180 of tubular 110 and axially extending surface 160 of insert 105. Once sealing member 125 engages surfaces 160, 180, sealing member 125 forms a barrier which prevents drilling fluid that may enter groove 115 through the annular space 195 between tubular 110 and inner preload ring 140/outer preload ring 145 from bypassing sealing member 125 and entering annular space 165 between insert 105 and tubular 110.

When seal 100 is subsequently exposed to increased temperatures, sealing member 125 expands, thereby increasing its ability to prevent drilling fluid from entering annular space 165. When temperatures surrounding sealing member 125 later decrease, sealing member 125 contracts. However, because seal 100 was preloaded when sealing member 125 was is in its natural, unexpanded state, sealing member 125 remains in contact with surfaces 160, 180 and thus continues to provide a barrier to fluid flow into annular space 165 even in the absence of thermal loads from, for example, heat generated by drilling.

Resilient ring 130 and angular ring 140 are both made of compliant material. Hence, these components 130, 140 are deformable under contact loads from sealing member 125 and pressure loads from drilling fluid entering groove 115. Further, when assembled as shown, resilient ring 130 and angular ring 140 are interfered, meaning they overlap, as indicated by dotted line 150, which represents the radially outer surface of ring 130. As shown, resilient ring 130 and angular ring 140 are interfered, or overlap, by a distance or interference 185. Groove 115 of insert 105 is bounded by axially and radially extending surfaces 160, 155, respectively, of insert 105. Angular ring 140 is radially translatable over radially extending surface 155 of insert 105 relative to resilient ring 130. Thus, interference 185 between resilient ring 130 and angular ring 140 increases as angular ring 140 translates radially inward over surface 155 further compressing resilient ring 130 against surfaces 155, 160 of insert 105, and decreases as angular ring 140 translates radially outward over surface 155. The dimensions of resilient ring 130 and angular ring 140 are selected such that these components 130, 140 remain interfered to a degree (meaning interference 185 is greater than zero) once installed between insert 105 and tubular 110. As such, resilient ring 130 and angular ring 140 do not separate, thereby preventing an annular space from opening between these components 130, 140 that may provide an extrusion path for sealing member 125.

Angular ring 140 has an angled surface 170 proximate sealing member 125. As previously described, sealing member 125 expands when exposed to temperatures higher than ambient. When sealing member 125 expands against angled surface 170 of ring 140, sealing member 125 deforms, due to its compliant nature, and is forced away from annular space 165 due to the angular nature of surface 170. At the same time, angular ring 140 displaces radially outward over surface 155 of insert 105 under force from expanding sealing member 125. As angular ring 140 displaces radially outward, an annular gap 175 between angular ring 140 and an inner surface 180 of tubular 110 decreases or closes. When sealing member 125 expands sufficiently to compress angular ring 140 against inner surface 180, gap 175 is closed, and angular ring 140 forms a barrier that prevents sealing member 125 and any drilling fluid in groove 115 from entering annular space 165. Thus, angular ring 140 prevents sealing member 125 from extruding into annular space 165.

Outer preload ring 145 and, in some embodiments, inner preload ring 135, allow for some thermal expansion of sealing member 125. This combined with the compliant nature of angular ring 140 and resilient ring 130 permits limited expansion of sealing member 125. By allowing sealing member 125 some room to expand, sealing member 125 is prevented from being compressed or squeezed during expansion to point where sealing member 125 becomes damaged and loses it resiliency.

As previously described, tubular 110 may form a portion of a drill string for creating a well bore and electronics (not shown) disposed within insert 105, and protected by seal 100, may perform downhole measurements. During assembly of the drill string, seal 100 is first assembled within groove 115 between insert 105 and tubular 110 prior to run-in of the drill string, including tubular 110, into the borehole. To assemble seal 100, resilient ring 130 is disposed within groove 115 abutting surfaces 155, 160, as shown in FIG. 1. Next, angular ring 140 is positioned radially outward of and in interference with resilient ring 130. Sealing member 125 is then positioned within groove 115 abutting first and angular rings 130, 140, respectively. Inner preload ring 135 is next positioned about insert 105 against sealing member 125. To complete assembly of seal 100, outer preload ring 145 is then disposed over inner preload ring 135. Insert 105 with seal 100 assembled thereto is then inserted within tubular 110, as shown.

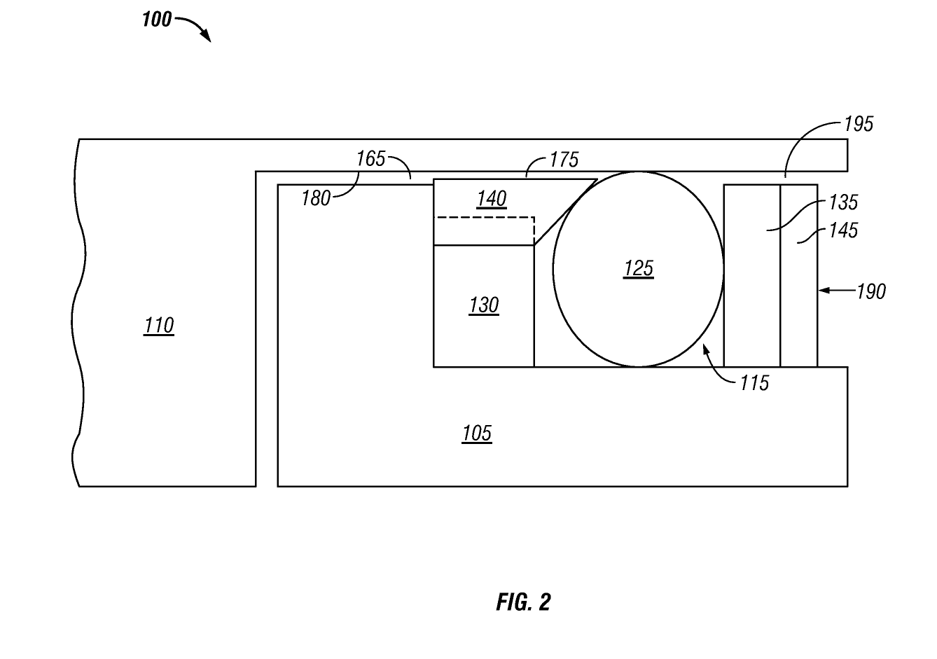

Inserting insert 105 within tubular 110 preloads sealing member 125 to a degree because sealing member 125 must be squeezed or compressed to fit between insert 105 and tubular 110. Next, seal 100 is further preloaded, as illustrated by FIG. 2. A pre-selected compressive force 190 is applied to outer preload ring 145. In response, inner preload ring 135 translates along surface 160 of insert 105 to compress sealing member 125. The compressive force applied is selected to ensure sealing member 125 remains engaged with both inner surface 180 of tubular 110 and axially extending surface 160 of insert 105 and provides a barrier preventing drilling fluid from entering annular space 165 between insert 105 and tubular 110, even when sealing member 125 assumes its natural state in the absence of thermal expansion. After seal 100 is preloaded, tubular 110 with insert 105 positioned therein may then be lowered into the borehole as part of the drill string.

During drilling operation, drilling fluid is delivered through the drill string, including tubular 110, to the drill bit. Due to its weight, the drilling fluid is highly pressurized and will pass through any exposed spaces between insert 105 and tubular 110, such as the annular space 195 between inner surface 180 of tubular 110 and inner preload ring 140/outer preload ring 145. However, due to preloading of seal 100, sealing member 125 prevents the drilling fluid from bypassing sealing member 125 and entering annular space 165 between insert 105 and tubular 110. At the same time, the temperature of sealing member 125 may also begin to rise in response to heat generated by drilling or increased downhole temperatures. As a result, sealing member 125 expands against angled surface 170 of angular ring 140, thereby displacing angular ring 140 along radially extending surface 155 of insert 105 and closing gap 175 between angular ring 140 and tubular 110.

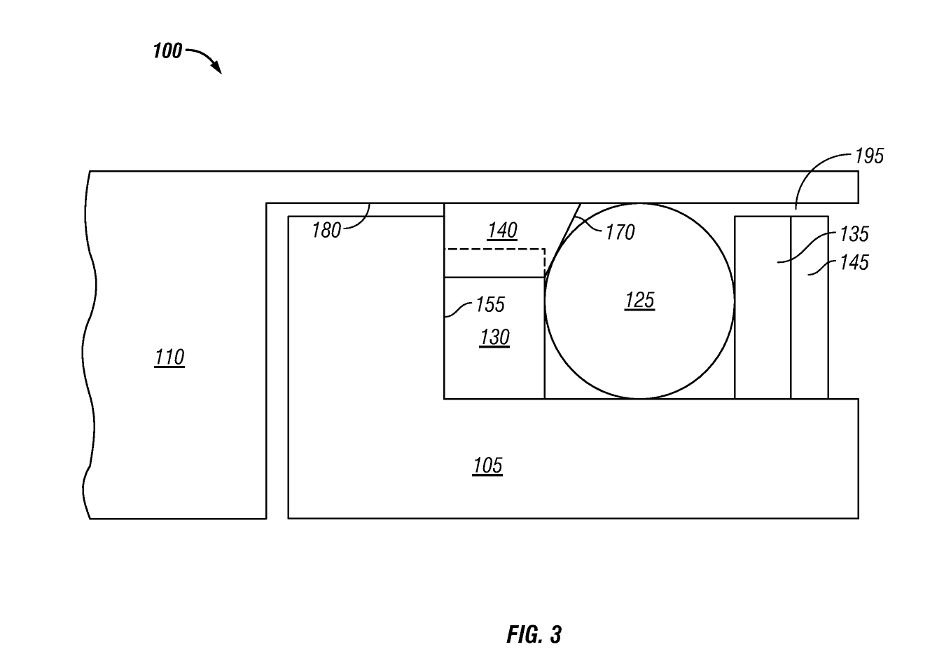

Referring to FIG. 3, continued expansion of sealing member 125 displaces angular ring 140 such that gap 175 is closed and angular ring 140 is compressed against inner surface 180 of tubular 110. Once gap 175 is closed, angular ring 140 prevents extrusion of sealing member 125 into annular space 165 as sealing member 125 continues to expand. Moreover, sealing member 125 does not extrude into annular space 195 due the passage of drilling fluid therethrough. The pressure of the drilling fluid acts on scaling element 125, pushing and deforming the compliant sealing element 125 away from annular space 195. With potential extrusion paths blocked, further expansion of sealing member 125 is instead accommodated by inner preload ring 135 and outer preload ring 145 as well as the compliant nature of angular ring 140 and resilient ring 130. By accommodating continued thermal expansion of sealing element 125 in this manner, sealing member 125 is prevented from over-compression to the point where sealing member 125 becomes damaged and loses it resiliency.

When temperatures surrounding seal 100 subsequently decrease, such as when drilling ceases, and sealing member 125 cools, sealing member 125 contracts. Despite its contraction, sealing member 125 remains in sealing engagement with surfaces 160, 180 due to preloading of seal 100 and continues to provide a barrier preventing drilling fluid from entering annular space 165 between insert 105 and tubular 110.

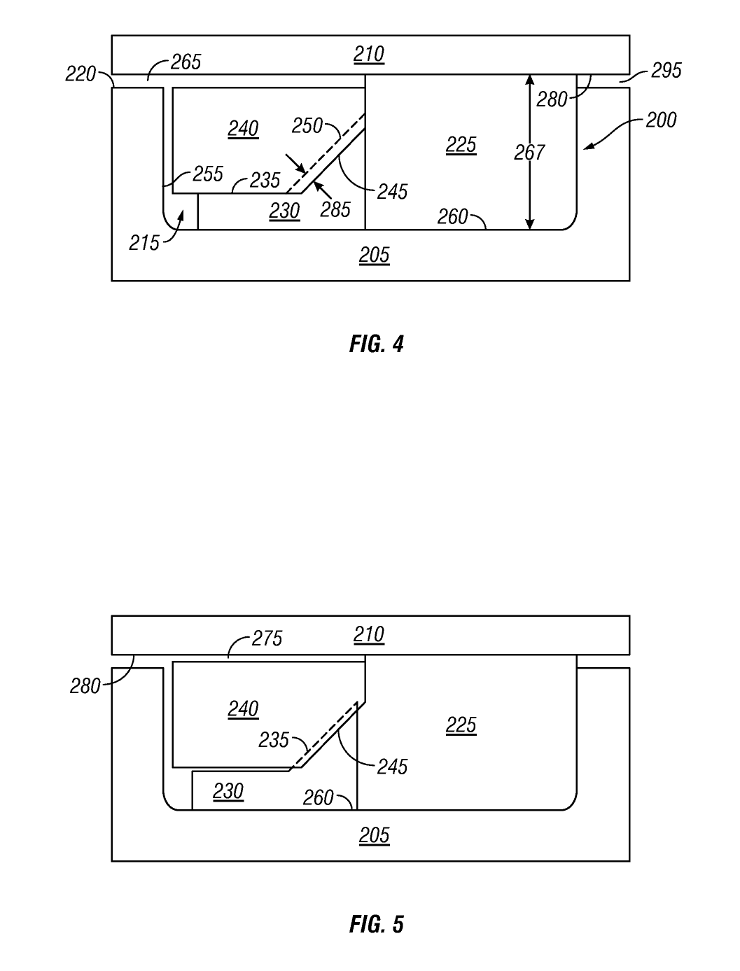

Turning now to FIG. 4, another embodiment of an anti-extrusion seal is depicted between a tubular 210 and an insert 205 disposed therein. In some embodiments, tubular 210 is a component of a drill string for creating a well bore, such as but not limited to a drill collar, and insert 205 is a chassis within which electronics (not shown) for downhole measurements are positioned. Seal 200 is seated in a groove 215 disposed in the outer surface 220 of insert 205 and, when preloaded as will be described, provides a barrier to fluid flow into an annular space 265 between insert 205 and tubular 210. Seal 200 includes a compliant sealing member 225 and a pair of angular rings 230, 240.

Sealing member 225 is compliant or flexible, and in some embodiments, comprises elastomeric material. Thus, sealing member 225 deforms in response to pressure loads, such as pressure loads from drilling fluid passing through tubular 210 and insert 205 disposed therein. Further, sealing member 225 is responsive to temperature change. As such, sealing member 225 expands when exposed to temperatures exceeding the ambient temperature, and contracts again when exposed to lower temperatures.

Moreover, sealing member 225 has a height or thickness 267 which exceeds the radial clearance between an outer surface 260 of insert 205 and an inner surface 280 of tubular 210. Consequently, sealing member 225 must be compressed to fit between insert 205 and tubular 210 as shown. This causes sealing member 225 to contact both inner surface 280 of tubular 210 and axially extending surface 260 of insert 205, thereby forming a barrier which prevents drilling fluid that may enter groove 215 from bypassing sealing member 225 and entering an annular space 265 between insert 205 and tubular 210.

Compressing sealing member 225 in this manner preloads seal 200. In contrast to the previous embodiment, compression of sealing member 225 between insert 205 and tubular 210 provides all of the preloading to seal 200. Preloading of seal 200 occurs at ambient temperature, when sealing member 225 assumes its natural state in the absence of thermal expansion. When seal 200 is subsequently exposed to increased temperatures, sealing member 225 expands, thereby increasing its ability to prevent drilling fluid from entering annular space 265. When temperatures surrounding sealing member 225 later decrease, sealing member 225 contracts. However, because seal 200 was preloaded when sealing member 225 was is in its natural, unexpanded state, sealing member 225 remains in contact with surfaces 260, 280 and thus continues to provide a barrier to fluid flow into annular space 265 even in the absence of thermal loads from, for example, heat generated by drilling.

Groove 215 of insert 205 is bounded by axially and radially extending surfaces 260, 255, respectively, of insert 205. Inner angular ring 230 is slideable over axially extending surface 260 of insert 205, and outer angular ring 240 is slideable over radially extending surface 255 of insert 205. Further, inner angular ring 230 has an angled outer surface 235 configured to receive a complimentary angled inner surface 245 of outer angular ring 240. Outer angular ring 240 is slideable over angled outer surface 235 relative to inner angular ring 230. Similarly, inner angular ring 230 is slideable over angled inner surface 245 relative to outer angular ring 240.

As previously described, sealing member 225 expands when exposed to temperatures higher than ambient, and subsequently contracts when surrounding temperatures decrease. When sealing member 225 expands against inner angular ring 230, inner angular ring 230 slides along surface 260 of insert 205 away from sealing member 225. In response, outer angular ring 240 is displaced by inner angular ring 230 radially outward due to the angled nature of surfaces 235, 245 and the interaction of outer angular ring 240 with radially extending surface 255 of insert 205. Conversely, when sealing member 225 contracts away from inner angular ring 230 and the compressive force on outer angular ring 240 exceeds that exerted by sealing member 225 on inner angular ring 230, outer angular ring 240 displaces radially inward. In response, inner angular ring 230 is displaced by outer angular ring 240 along surface 260 of insert 205 toward sealing member 225.

Further, inner and outer angular rings 230, 240, when assembled as shown, are interfered, or overlap, as indicated by dotted line 250, which represents a portion of radially outer surface 235 of ring 230. As shown, inner and outer angular rings 230, 240 are interfered, or overlap, by a distance or interference 285. The dimensions of rings 230, 240 are selected such they remain overlapped to a degree (meaning overlap 285 is greater than zero) once installed between insert 205 and tubular 210. As such, inner and outer angular rings 230, 240 do not separate despite relative movement, thereby preventing an annular space from opening between inner and outer angular 230, 240 that may provide an extrusion path for sealing member 225.

Inner and outer angular rings 230, 240, respectively, are both made of compliant material. Hence, these components 230, 240 are deformable under contact loads from sealing member 225 and pressure loads from drilling fluid entering groove 215. Also, the compliant nature of angular rings 230, 240 permits limited expansion of sealing member 225. By allowing sealing member 225 some room to expand, sealing member 225 is prevented from being compressed or squeezed during expansion to point where sealing member 225 becomes damaged and loses it resiliency.

As previously described, tubular 210 may form a portion of a drill string for creating a well bore, and electronics (not shown) disposed within insert 205, and protected by seal 200, may perform downhole measurements. During assembly of the drill string, seal 200 is first assembled within groove 215 between insert 205 and tubular 210 prior to run-in of the drill string, including tubular 210, into the borehole. To assemble seal 200, angular ring 230 disposed within groove 215 abutting surfaces 255, 260, as shown in FIG. 4. Next, angular ring 240 is positioned radially outward of and in interference with angular ring 230. Sealing member 225 is then positioned within groove 215 between insert 205 and tubular 210 abutting angular rings 230, 240. Positioning sealing member 225 between insert 205 and tubular 210 preloads sealing member 225 because sealing member 225 must be squeezed or compressed to fit between insert 205 and tubular 210. Assembly of seal 200 is then complete. Tubular 210 with insert 205 positioned therein may then be lowered into the borehole as part of the drill string.

During drilling operation, drilling fluid is delivered through the drill string, including tubular 210, to the drill bit. Due to its weight, the drilling fluid is highly pressurized and will pass through any exposed spaces between insert 205 and tubular 210, such as the annular space 295 between inner surface 280 of tubular 210 and insert 205. Even so, sealing member 225 prevents the drilling fluid from bypassing sealing member 225 and entering annular space 265 between insert 205 and tubular 210 due to preloading of seal 200.

The temperature of sealing member 225 may also begin to rise in response to heat generated by drilling or increased downhole temperatures. As a result, sealing member 225 expands against angular ring 230, thereby displacing angular ring 230 along axially extending surface 260 of insert 205, as illustrated by FIG. 5. In turn, angular ring 230 displaces outer angular ring 240 radially outward due to the angled nature of surfaces 235, 245. As outer angular ring 240 displaces radially outward, a gap 275 between outer angular ring 240 and inner surface 280 of tubular 210 closes.

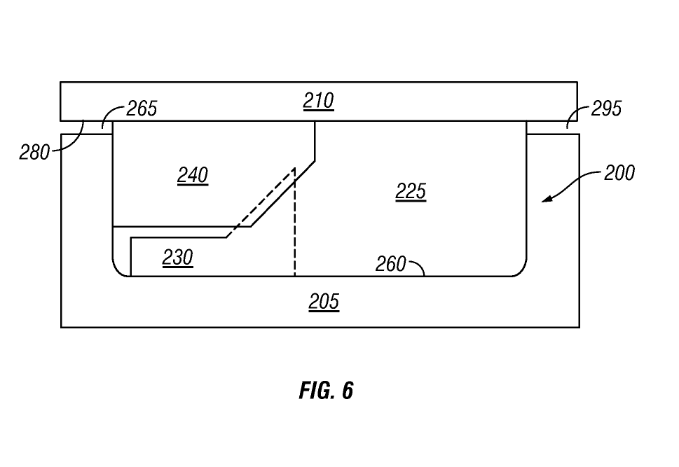

Referring now to FIG. 6, continued expansion of sealing member 225 displaces angular rings 230, 240 such that gap 275 is closed and angular ring 240 is compressed against inner surface 280 of tubular 210. Once gap 275 is closed, angular ring 240 prevents extrusion of sealing member 225 into annular space 265 as sealing member 225 continues to expand. Moreover, sealing member 225 does not extrude into annular space 295 due the passage of drilling fluid therethrough. The pressure of the drilling fluid acts on sealing element 225, pushing and deforming the compliant sealing element 225 away from annular space 295. With potential extrusion paths blocked, further expansion of sealing member 225 is instead accommodated by the compliant nature of angular rings 230, 240. By accommodating continued thermal expansion of sealing element 225 in this manner, sealing member 225 is prevented from over-compression to the point where sealing member 225 becomes damaged and loses it resiliency.

When temperatures surrounding seal 200 decrease, such as when drilling ceases, and sealing member 225 cools, sealing member 225 contracts. Despite its contraction, sealing member 225 remains in sealing engagement with surfaces 260, 280 due to preloading of seal 200 and continues to provide a barrier preventing drilling fluid from entering annular space 265 between insert 205 and tubular 210.

While preferred embodiments of this invention have been shown and described, modifications thereof can be made by one skilled in the art without departing from the scope or teaching of this invention. The embodiments described herein are exemplary only and are not limiting. Many variations and modifications of the system and apparatus are possible and are within the scope of the invention. For example, the relative dimensions of various parts, the materials from which the various parts are made, and other parameters can be varied, so long as the methods and apparatus retain the advantages discussed herein. Accordingly, the scope of protection is not limited to the embodiments described herein, but is only limited by the claims that follow, the scope of which shall include all equivalents of the subject matter of the claims.

1. A sealing system comprising:
a sealing member compressed between a chassis and a tubular, the sealing member comprising a temperature and comprising a resilient material that is expandable as the temperature increases and contractible as the temperature decreases; and
an outer ring;
wherein the outer ring is displaceable to close an annulus between an outer surface of the outer ring and the inner surface of the tubular by expansion of the sealing element, whereby the sealing member is prevented from extruding into the annulus; and
wherein the outer ring comprises a compliant material that is deformable under load from the sealing element as the sealing element expands.

2. The sealing system of claim 1, wherein the outer ring slideably engages a radially extending surface of the chassis and has an angular surface engaging the sealing member, wherein the outer ring is radially displaceable when the sealing member expands against the outer ring and the outer ring slides along the radially extending surface of the chassis.

3. The sealing system of claim 1, further comprising a preload ring, wherein the sealing member is disposed between the outer ring and the preload ring, the preload ring operable to further compress the sealing member.

4. The sealing system of claim 3, wherein the preload ring is deformable under load from the sealing member as the sealing member expands.

5. The sealing system of claim 1, further comprising an inner ring disposed radially inward of and in overlapping engagement with the outer ring.

6. The sealing system of claim 5, wherein the inner ring comprises a compliant material that is deformable under load from the sealing element as the sealing element expands.

7. The sealing system of claim 1, wherein the outer ring has an angular surface slideably engaging an angular surface of the inner ring, wherein the inner ring is axially displaceable to radially displace the outer ring.

8. A sealing system comprising:
a sealing member compressed between a chassis and a tubular, the sealing member comprising a temperature and comprising a resilient material that is expandable as the temperature increases and contractible as the temperature decreases; and
an outer ring disposed adjacent the sealing member and slideably engaging a radially extending surface of the chassis, the outer ring comprising:
a substantially axially extending inner surface;
an angled surface extending from the inner surface and engaging the sealing member; and
a substantially axially extending outer surface disposed radially inward of an inner surface of the tubular;
wherein the sealing member is expandable to displace the outer ring radially outward, whereby an annulus between the outer surface of the outer ring and an inner surface of the tubular is closed and the sealing member is deflected by the angled surface of the outer ring away from the annulus.

9. The sealing system of claim 9, wherein the outer ring is displaceable radially outward as the sealing member expands against the outer ring and the outer ring slides along the radially extending surface of the chassis.

10. The sealing system of claim 9, further comprising a preload ring, wherein the sealing member is disposed between the outer ring and the preload ring, the preload ring operable to further compress the sealing member.

11. The sealing system of claim 11, wherein the preload ring is deformable under load from the sealing member as the sealing member expands.

12. The sealing system of claim 12, wherein the preload ring is one of a Belleville washer and a wave spring.

13. The sealing system of claim 9, further comprising an inner ring disposed radially inward of and in overlapping engagement with the outer ring.

14. The sealing system of claim 14, wherein each of the inner ring and the outer ring comprises a compliant material that is deformable under load from the sealing element as the sealing element expands.

15. A sealing system comprising:
a sealing member compressed between a chassis and a tubular, the sealing comprising a temperature and comprising a resilient material that is expandable member as the temperature increases and contractible as the temperature decreases;
an inner ring disposed adjacent the sealing member and slideably engaging an axially extending surface of the chassis, the inner ring comprising:
an axially extending outer surface; and
an angled surface extending from the outer surface; and
an outer ring disposed radially outward of the inner ring, the outer ring comprising:
a substantially axially extending inner surface;
an angled surface extending from the inner surface and slideably engaging the angled surface of the inner ring; and
a substantially axially extending outer surface disposed radially inward of an inner surface of the tubular;
wherein the sealing member is expandable to axially displace the inner ring, whereby the outer ring displaces radially outward to close an annulus between the outer surface of the outer ring and an inner surface of the tubular, whereby the sealing member is prevented from extruding into the annulus.

16. The sealing system of claim 16, wherein the angled surface of the outer ring and the angled surface of the inner ring are interfered.

17. The sealing system of claim 16, wherein the inner ring comprises a compliant material that is deformable under load from the sealing element as the sealing element expands.

18. The sealing system of claim 16, wherein the outer ring comprises a compliant material that is deformable under load from the sealing element as the sealing element expands.

19. The sealing system of claim 16, wherein the outer ring slideably engages a radially extending surface of the chassis.
